(19) United States
(12) Patent Application Publication
(10) Pub. No.: US 2019/0216056 A1
(43) Pub. Date: Jul. 18, 2019

(54) ANIMAL RESTRAINT SYSTEMS, SECURING DEVICES, AND RELATED ADJUSTMENT MECHANISMS

(71) Applicant: VUFF LLC, Newburgh, NY (US)

(72) Inventor: AARON LOWN, Newburgh, NY (US)

(73) Assignee: VUFF LLC, Newburgh, NY (US)

(21) Appl. No.: 16/329,058

(22) PCT Filed: Sep. 8, 2017
(86) PCT No.: PCT/US17/50829

§ 371 Date: Feb. 27, 2019

Related U.S. Application Data
(60) Provisional application No. 62/385,171, filed on Sep. 8, 2016.

(51) Int. Cl. A01K 27/00

(52) U.S. Cl. CPC A01K 27/001; A01K 27/003

(57) ABSTRACT

An animal restraint system, securing devices, and related adjustment mechanisms are provided that involve combination with modified braided sleeving system. A leash system is provided with a flexible profile and an inner restraint resistant system with an optional length adjustment feature. A collar system provides a smooth infinite adjustment arrangement with a locking member. Presentation and packaging options provide improved presentation in a small location.

### CROSS REFERENCE TO RELATED APPLICATIONS

This application relates to and claims priority from U.S. Prov. Ser. No. 62/385,171 filed Sep. 8, 2016, the entire contents of which are incorporated herein by reference.

### FIGURE SELECTED FOR PUBLICATION

FIG. 1

### BACKGROUND OF THE INVENTION

### Field of the Invention

The present invention relates to integrated animal restraint systems, securing devices, and related adjustment mechanisms. More particularly, the present invention provides leashes, collars, adjustment mechanisms, and presentation and packaging arrangements, and has related application in the industrial animal husbandry fields of dairy farming, meat-production, animal shipping and transfer, and sports and business matters involving animals. Additionally, alternative uses for such devices could be in the garment industry or packaging industry as adjustable belts or adjustable binding or securing members.

### Description of the Related Art

Known are industrial braided sleeve products employed to provide a protective shield around vulnerable electrical cables and fluid lines and telecommunication cables. Typically, such braided sleeves surround one or more cables, lines, etc. that extend from a source location (internet portal, water-supply, electrical hub or server etc.) to a distant work location (computer consol, water-manifold, electrical motor, local-computer etc.). Because each end of a braided sleeve is subject to fraying and loss of inter-weaving, the ends are normally uniformly pressure-crimped into metal brackets which are then threaded into fixed transfer boxes, manifold ports, or other fittings to provide a continuous shield for the electrical wire or fluid conduit. The reason is that injury to the sleeved (to be protected) item is costly and time consuming to repair and will provide a disruption in service. In practice these braided sleeve products are not used in tension at all, because to do so would place undue and damaging compressive stress on the so-contained electrical cables, telecommunication cables, and fluid lines and because doing so would place tearing stress on the pressure-crimped sleeve ends. For similar reasons conventionally used braded sleeve products are not placed in sharp-acute-bending angles. The braided sleeve products are used for abrasion resistance through selection of the material used in the braded weave itself. Additionally, where identification is necessary different colors may be selected to allow easy visual tracking.

Examples of such braided sleeving products are known under the trademark TEXFLEX® from Techflex, Inc. of Sparta, N.Y., at www.techflex.com, where braided sleeves are provided in a plurality of materials including long chain polymers, polyethylene terephalate, and in other materials. Braided sleeves are in the form of a flexible sheath having a defined outer boundary formed from a plurality of filaments that surround the interior bounded-volume. Since the braded sleeves may be folded or manipulated the bounded-volume is understood to be the interior of the braided sleeve. The filaments may be formed of metals (including but not limited to copper, brass, steel, and other alloys), complex man made fiber polymers (including but not limited to PTFE, PET, Nylon®, Keviar®, Spectra®, and other high-cut-resistance polymers and plastics), natural fibers (including but not limited to hemp, cotton, wool, and other natural fibers), and related combinations thereof. It will be understood, that braided sleeves may be woven from multiple different materials (metals, polymers, natural fibers) in single or multi-strand combinations without departing from the spirit of the present invention. Similarly, such braided sleeves are available in a variety of different colors, different woven patterns, different outer perimeters without limitation (outer boundary length that surrounds a two-dimensional shape, but is not restricted to a specific geometry (circle, pentagon, triangle, etc.) and includes irregular shapes, ovoids, closed arc-loops etc.).

Industrial applications of animal restraints and adjustment mechanisms are well known in the form of leashes and collars. Typically, there is a metal link connection between a leash and a collar for attachment. Typically, the collar is adjustable using a belt-and-buckle-with-tongue-and-hole arrangement to adjust to neck-dimension of an animal. For a typical collar, typically the un-restrained end is left exposed detrimentally, and the sole restraint stress-focus is on the tongue-and-hole arrangement which is very weak. Also typically a leash is an extended leather member with a snap hook on one end and a handle on the opposite end. Unfortunately the leash handle is not cushioned in any way and the entire leash is not adaptable to length, or easy to compact into a small dimension. Unfortunately, such conventional leashes and collars are not cut resistant, are not sufficiently adjustable, will mold and degrade in wet environments, and may host bacteria or other pathogens allowing for transfer between animals in a work or home environment providing a costly detriment.

Accordingly, there is a need for improved and adaptive animal restraint systems, securing devices, and related adjustment mechanisms that address at least one of the concerns noted above.

### ASPECTS AND SUMMARY OF THE INVENTION

The present invention provides an animal restraint system, securing devices, and related adjustment mechanisms are provided that involve combination with modified braided sleeving system. A leash system is provided with a flexible profile and an inner restraint resistant system with an optional length adjustment feature. A collar system provides a smooth adjustment arrangement with a locking member. Presentation and packaging options provide improved presentation in a small location.

In another aspect of the present invention, there is provided a braided restraint system having one or more internal braided sheaths linking a hand-holding-end and a restraint end. In another alternative embodiment a length adjustment feature is provided for a leash member and a length or diameter adjustment feature is provided for a collar member.

In another aspect of the present invention, there are provided alternative packaging and display arrangements for the restraint system and components wherein the packaging and display arrangements provide a compact shape and secure presentation.

Another aspect of the present invention is to provide adjustable length systems for a leash and a collar that readily adapt to braided sleeving products with secure adjustments and connections.

Presentation and packaging systems allow a compact and secure arrangement in a small location for improved shelf-space utilization in marketing.

In another aspect of the present invention locking engagement components are provided that are adapted to secure a braided medium and allow ready adaptation to alternative uses and improved manufacturing, and these different locking engagement components can be used for locations on a leash or a collar system.

In another alternative aspect of the present invention, a double walled handle portion of a leash formed from braided sleeving members is provided wherein an inner braided portion performs a stress engaging function and has a shorter relative path length than an outer braided portion for the same handle, and an outer braided portion performs a cushioning contour support function during stress and has a longer path length then the inner braided portion relative to a handle securing member of a leash.

It is another alternative aspect of the present invention to provide a collar having an adjustable length feature that is readily and securely engaged allowing a single collar item to fit a plurality of different sizes wherein the braided sleeve arrangement receives the adjustment free-end so as provide a smooth and continuous profile.

In another aspect of the present invention a fixing system includes locking geometry to physical crimp and engage a braded sleeve portion without damage to the same to allow for an adjustment of a collar or leash or other animal restraint device.

It will be also understood that the present invention, including hook systems, collar fixing systems, and the internal arrangements of each feature of the current disclosure, may be used for other restraint systems, including but not limited to full or partial body harnesses, carry handles or carry straps for small animals, composite use with animal protective devices (thermal covers, blast/shot covers, animal flotation covers, animal low-light identification covers), and animal transport packs, including related saddlery and animal products.

According to another alternative aspect of the present invention, there is provided a restraint system, comprising: a leash system having an outer braided sheath with a handle system at a first end and a hook system at a second end, the handle system including outer braided handle portion and extending there through an inner braided handle portion therein each respectively fixed at a handle fixing member, the outer braided handle portion having a first length relative to the handle fixing member and the the inner braided handle portion having a second length relative to the inner fixing member, and the first length being greater than the second length whereby a force applied to the handle fixing member is initially restrained by the inner braided handle portion during a use.

According to another alternative aspect of the present invention, there is provided a restraint system, further comprising: an outer braided leash portion along the outer braided sheath and secured between the handle fixing member and the hook system at the second end, an inner braided leash portion extending within the outer braided leash portion and fixed to the hook system, a bounded opening along the outer braided leash portion, and a portion of the inner braided leash portion extending through the bounded opening during the use for manual adjustment of a use-length of the outer braided leash portion.

According to another alternative aspect of the present invention, there is provided a restraint system, further comprising: a collar system having a collar braided sleeve portion with a first open end and a second closed end, a collar fixing system secured to the first open end of the collar braided sleeve portion, the second closed end adjustably sliding through the collar fixing system during an adjustment to a selected length, and a locking system for securely engaging between the collar fixing system and the second closed end during the adjustment.

According to another alternative aspect of the present invention, there is provided a restraint system, further comprising: a leash system having an outer braided sheath with a handle system at a first end and a hook system at a second end, the handle system including outer braided handle portion and extending there through an inner braided handle portion therein each respectively fixed at a handle fixing member, the outer braided handle portion having a first length relative to the handle fixing member and the the inner braided handle portion having a second length relative to the inner fixing member, the first length being greater than the second length whereby a force applied to the handle fixing member is initially restrained by the inner braided handle portion during a use, an outer braided leash portion along the outer braided sheath and secured between the handle fixing member and the hook system at the second end, an inner braided leash portion extending within the outer braided leash portion and fixed to the hook system, a bounded opening along the outer braided leash portion, a portion of the inner braided leash portion extending through the bounded opening during the use for manual adjustment of a use-length of the outer braided leash portion, and a collar system having a collar braided sleeve portion with a first open end and a second closed end, a collar fixing system secured to the first open end of the collar braided sleeve portion, the second closed end adjustably sliding through the collar fixing system during an adjustment to a selected length, and a locking system for securely engaging between the collar fixing system and the second closed end during the adjustment.

According to another alternative aspect of the present invention, there is provided a restraint system, comprising: a leash system having an outer braided sheath with a handle system at a first end and a hook system at a second end; the handle system including an outer braided handle portion and extending on an inside therethrough is an inner braided handle portion therein each respectively fixed to a handle fixing assembly; the outer braided handle portion having a first length relative to the handle fixing assembly and the inner braided handle portion having a second length relative to the inner fixing member; and the first length being greater than the second length, whereby a force applied to the handle fixing assembly first tensions the inner braided handle portion during a use and does not tension the outer braded handle portion.

According to another alternative aspect of the present invention, there is provided a restraint system, further comprising: an outer braided leash portion along the outer braided sheath and secured between the handle fixing member at a first end and the hook system at the second end; an inner braided leash portion having extending within the outer braided leash portion and fixed to the hook system at a first inner braded leash end; a bounded opening along a side wall of the outer braided leash portion; a second inner braded leash end opposite the first inner braded leash end; and a portion of the second inner braded leash end of the inner braided leash portion extending through the bounded opening during the use, thereby enabling a manual adjustment of a use-length of the outer braided leash portion.

According to another alternative aspect of the present invention, there is provided a restraint system, wherein: the handle fixing assembly further comprising: an outer handle fixing sleeve having an inner tapered profile surface and at least one engagement contour therein; a first and a second inner anvil member each respectively having an outer contour that is a portion of the inner tapered profile surface of the outer handle fixing sleeve; each outer contour of the first and the second inner anvil members having a respective receiving contour shaped to engage the one engagement contour of the outer handle fixing sleeve and secure the first and the second inner anvil members within the outer handle fixing sleeve; the first and the second inner anvil members each respectively having an inner receiving contour profile and at least one engagement member; and a respective first end portion of the handle system and a second end portion of the handle system received within the first and the second inner anvil members and aligned with the inner receiving contour profiles and engaging the at least one engagement member whereby respective lengths of the inner braided handle portion and the outer braided handle portion are fixed relative to the handle fixing assembly.

According to another alternative aspect of the present invention, there is provided a restraint system, further comprising: a first bounded opening in the respective first end portion of the handle system and a second bounded opening in the send end portion of the handle system; the at least one engagement member on at least one of the inner receiving contour profiles of the first and the second inner anvil members; and the at least one engagement member extending through the first and the second bounded openings of the handle system and engaging the other of the inner receiving contour profiles of the first and the second inner anvil members.

According to another alternative aspect of the present invention, there is provided a restraint system, wherein: the handle fixing assembly further comprising: an outer handle fixing sleeve having an inner tapered profile surface and at least one engagement contour therein; an inner anvil member having an outer tapered profile surface corresponding to the inner tapered profile of the outer fixing sleeve whereby upon insertion of the inner anvil member into the outer handle fixing sleeve the inner tapered profile surface and the outer tapered profile surface are urged into contact; and a respective first end portion of the handle system and a second end portion of the handle system received between the inner tapered profile surface of the outer handle fixing sleeve and the outer tapered profile surface of the inner anvil member, whereby respective lengths of the inner braided handle portion and the outer braided handle portion are fixed relative to the handle fixing assembly.

According to another alternative aspect of the present invention, there is provided a restraint system, wherein: the second end of the outer braided sheath of the leash system having an open second end fixably engaging the hook system; the hook system further comprising: a hook; an outer hook ring sleeve member having an inner contour; an inner hook sleeve member having an outer contour and engaging the hook; an inner surface of the open second end of the outer braided sheath on the outer contour of the inner hook sleeve member; an outer surface of the open send end of the outer braided sheath pressed by the inner contour of the outer hook ring sleeve member during assembly; at least one inner hook sleeve engaging profile on the outer contour of the inner hook sleeve member; at least inner contour engaging profile on the outer hook ring sleeve member; and the inner hook sleeve engaging profile fixably engaging the inner contour engaging profile thereby securing the second end of the outer braided sheath to the hook system.

According to another alternative aspect of the present invention, there is provided a restraint system, wherein: the inner hook sleeve member is a first inner sleeve and a second inner sleeve; the outer contour of the hook sleeve member is a first outer contour portion and a second outer contour portion of respective the first inner sleeve and the second inner sleeve; a plurality of hook sleeve engaging profiles on respective the first outer contour portion and the second outer contour portion.

According to another alternative aspect of the present invention, there is provided a restraint system, wherein: the first inner sleeve and the second inner sleeve each further comprise a respective first threaded opening and a respective second threaded opening; and the inner hook sleeve member further comprises a threaded member threadaby engaging respective the first and the second threaded openings thereby securing the first inner sleeve to the second inner sleeve.

According to another alternative aspect of the present invention, there is provided a restraint system, further comprising: a pivot member protruding from the hook; a pivot receiving cavity in the inner hook sleeve member; and the hook in the hook system being pivotably secured to the second end of the outer braided sheath.

According to another alternative aspect of the present invention, there is provided a restraint system, comprising: a collar system having a collar braided sleeve portion with a first open end and a second closed end; a collar fixing system secured to the first open end of the collar braided sleeve portion; the second closed end adjustably sliding through the collar fixing system and into an inner portion of the collar braided sleeve portion during an adjustment to a selected length thereby forming a continuous loop; and a locking system for securely engaging between the collar fixing system and a designed portion the second closed end during the adjustment, whereby the collar system provides an infinite adjustability of a dimension of the continuous loop.

According to another alternative aspect of the present invention, there is provided a restraint system, comprising: a collar system including a braided sleeve portion having a first open loose end and a second open loose end; an inner wedge assembly having a inner wedge inner portion with an inner wedge outer profile and an inner wedge outer portion with an inner wedge inner profile; the inner wedge outer profile being complementary to the inner wedge inner profile; the inner wedge outer profile including a plurality of inner wedge engaging members; the first open loose end on the inner wedge outer profile engaging at least one of the plurality of inner wedge engaging members; the inner wedge outer profile of the inner wedge outer portion fixably engaging the first open loose end and the inner wedge inner portion and forming a closed end of the collar system; the closed end of the collar system being within the braided sleeve portion forming a continuous adjustable loop; the inner wedge outer portion having an inner wedge exterior profile and at least one receiving recess; an open anchor wedge having an open inner passage and an outer anchor wedge profile including a plurality of anchor wedge fixing engaging protuberances and at least one releasable engaging protuberance; the second open loose end on the outer anchor wedge profile and fixably engaging the anchor wedge fixing engaging protuberances and a portion of the braided sleeve portion extending through the open inner passage forming the continuous adjustable loop; an anchor member slidably adjustable along the braided sleeve portion and having an inner profile shaped to releasably engage the releaseable engaging protuberance of the open anchor wedge thereby securing the second open loose end to the open anchor wedge forming an open end for the collar system; the closed end of the collar system being slidably and adjustably received within the open end for the collar system and a sliding lock member being slidably positioned along the continuous adjustable loop; and the sliding lock member having an inner surface with at least one lock protuberance being releasably engagable with the at least one receiving recess of the inner wedge outer portion; whereby during an adjustment use the sliding lock member releasably disengages the inner wedge outer portion of the inner wedge assembly and after the adjustment the sliding lock member engages the inner wedge portion at a desired location along the continuous adjustable loop.

According to another alternative aspect of the present invention, there is provided a restraint system, comprising: a leash system having an outer braided sheath with a handle system at a first end and a hook system at a second end; the handle system including an outer braided handle portion and extending on an inside therethrough is an inner braided handle portion therein each respectively fixed to a handle fixing assembly; the outer braided handle portion having a first length relative to the handle fixing assembly and the inner braided handle portion having a second length relative to the inner fixing member; the first length being greater than the second length, whereby a force applied to the handle fixing assembly first tensions the inner braided handle portion during a use and does not tension the outer braded handle portion; a collar system having a collar braided sleeve portion with a first open end and a second closed end; a collar fixing system secured to the first open end of the collar braided sleeve portion; the second closed end adjustably sliding through the collar fixing system during an adjustment to a selected length; and a locking system for securely engaging between the collar fixing system and the second closed end during the adjustment.

According to another alternative aspect of the present invention, there is provided a restraint system, further comprising: an outer braided leash portion along the outer braided sheath and secured between the handle fixing assembly at a first end and the hook system at the second end; an inner braided leash portion having extending within the outer braided leash portion and fixed to the hook system at a first inner braded leash end; a bounded opening along a side wall of the outer braided leash portion; a second inner braded leash end opposite the first inner braded leash end; and a portion of the second inner braded leash end of the inner braided leash portion extending through the bounded opening during the use, thereby enabling a manual adjustment of a use-length of the outer braided leash portion.

According to another alternative aspect of the present invention, there is provided a restraint system, comprising: a leash system having an outer braided sheath with a handle system at a first end and a hook system at a second end; the handle system including an outer braided handle portion and extending on an inside therethrough is an inner braided handle portion therein each respectively fixed to a handle fixing assembly; the outer braided handle portion having a first length relative to the handle fixing assembly and the inner braided handle portion having a second length relative to the inner fixing member; the first length being greater than the second length, whereby a force applied to the handle fixing assembly first tensions the inner braided handle portion during a use and does not tension the outer braded handle portion; the handle fixing assembly further comprising: an outer handle fixing sleeve having an inner tapered profile surface and at least one engagement contour therein; a first and a second inner anvil member each respectively having an outer contour that is a portion of the inner tapered profile surface of the outer handle fixing sleeve; each outer contour of the first and the second inner anvil members having a respective receiving contour shaped to engage the one engagement contour of the outer handle fixing sleeve and secure the first and the second inner anvil members within the outer handle fixing sleeve; the first and the second inner anvil members each respectively having an inner receiving contour profile and at least one engagement member; and a respective first end portion of the handle system and a second end portion of the handle system received within the first and the second inner anvil members and aligned with the inner receiving contour profiles and engaging the at least one engagement member whereby respective lengths of the inner braided handle portion and the outer braided handle portion are fixed relative to the handle fixing assembly; a collar system having a collar braided sleeve portion with a first open end and a second closed end; a collar fixing system secured to the first open end of the collar braided sleeve portion; the second closed end adjustably sliding through the collar fixing system and into an inner portion of the collar braided sleeve portion during an adjustment to a selected length thereby forming a continuous loop; and a locking system for securely engaging between the collar fixing system and a designed portion the second closed end during the adjustment, whereby the collar system provides an infinite adjustability of a dimension of the continuous loop.

The above and other aspects, features and advantages of the present invention will become apparent from the following description read in conjunction with the accompanying drawings, in which like reference numerals designate the same elements.

### BRIEF DESCRIPTION OF THE DRAWINGS

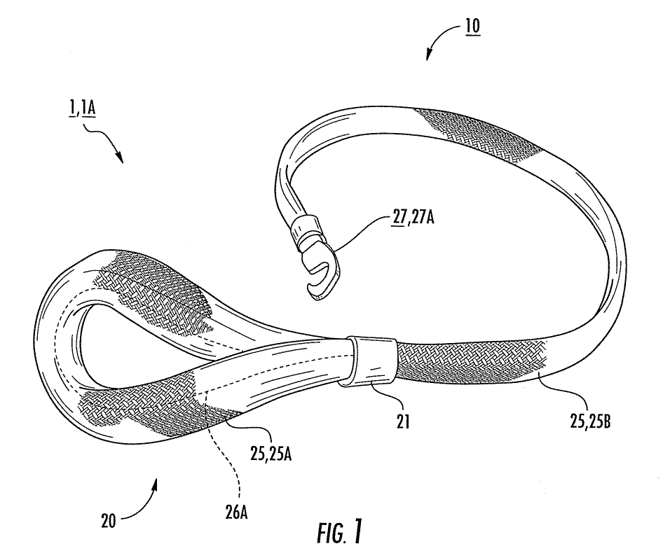

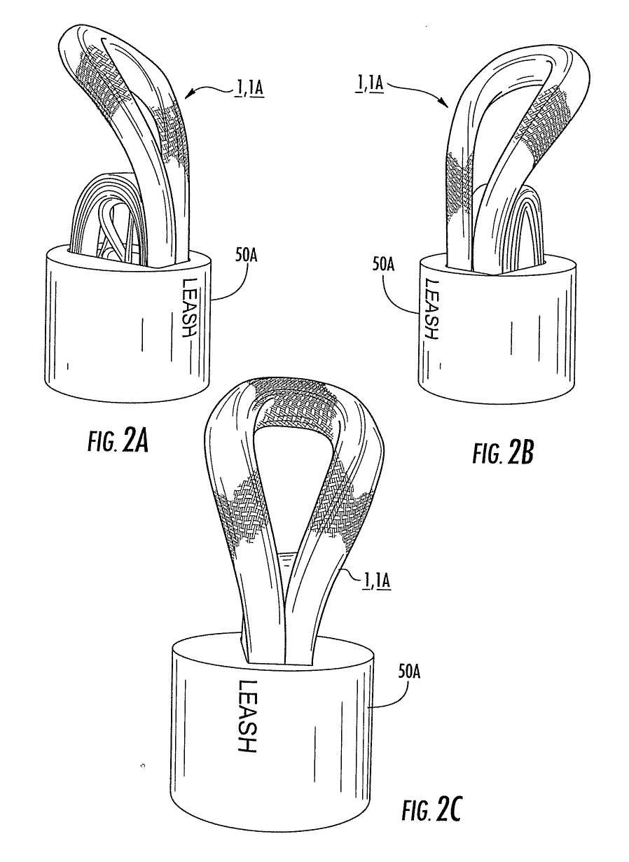

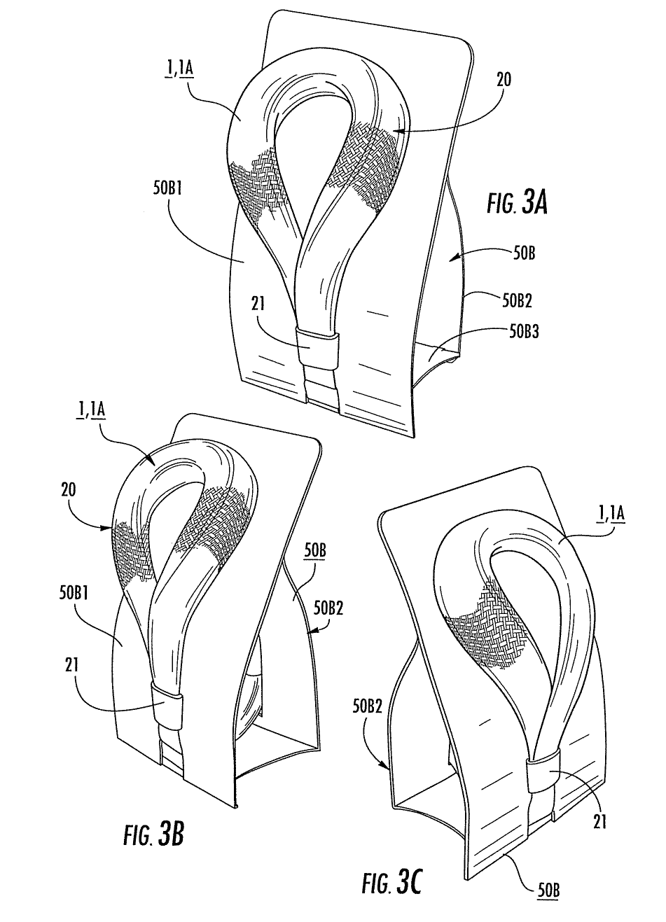

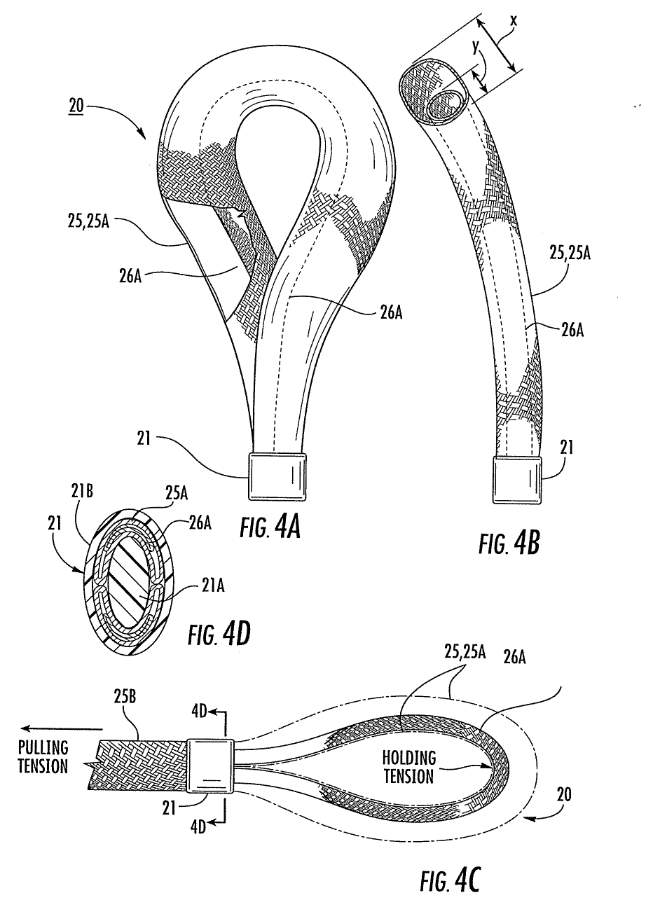

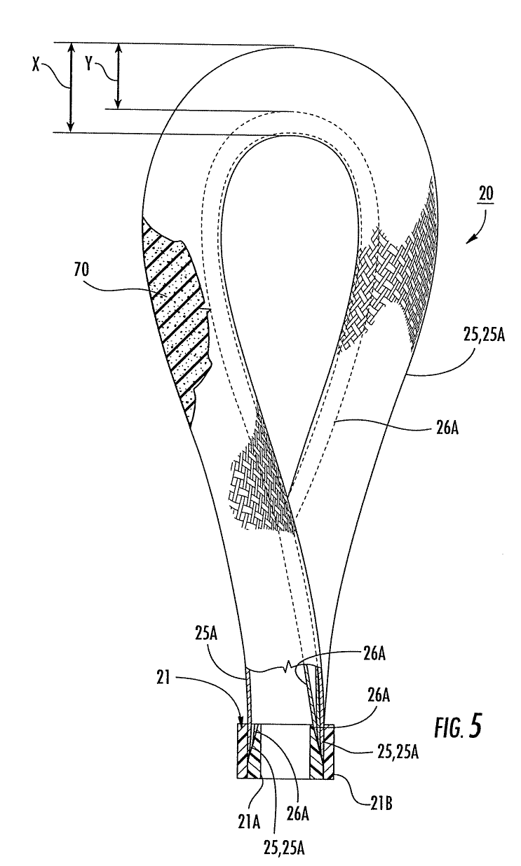

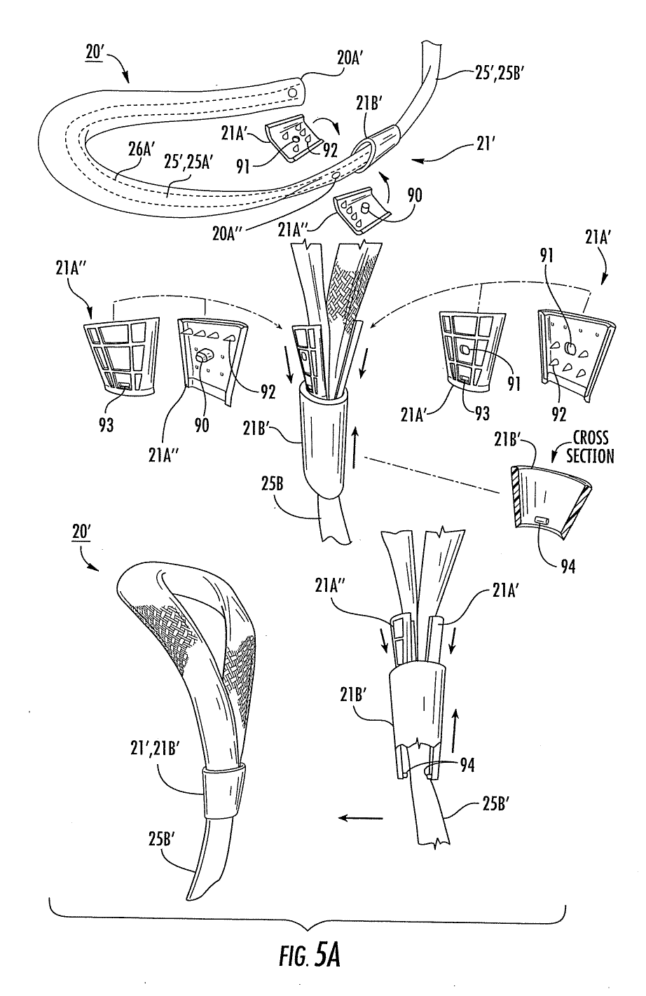

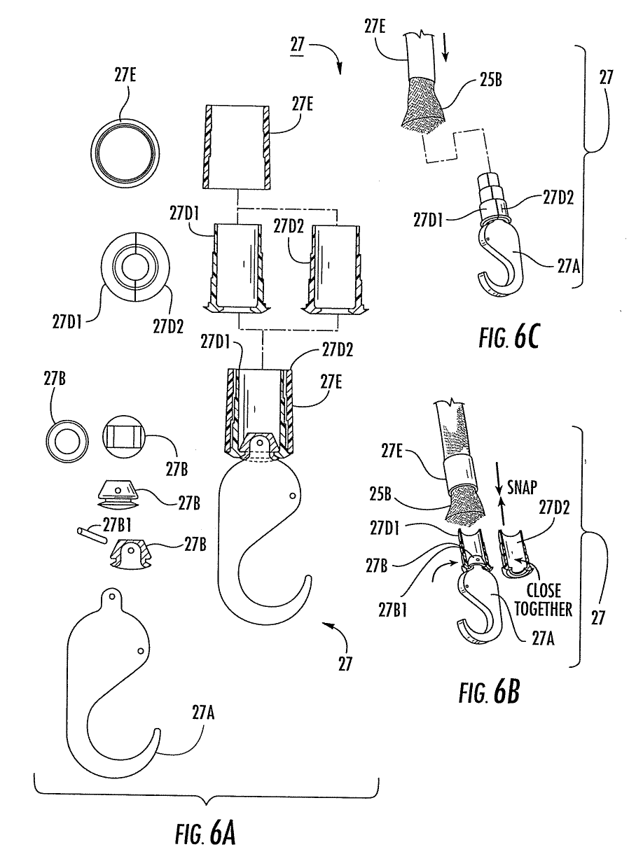

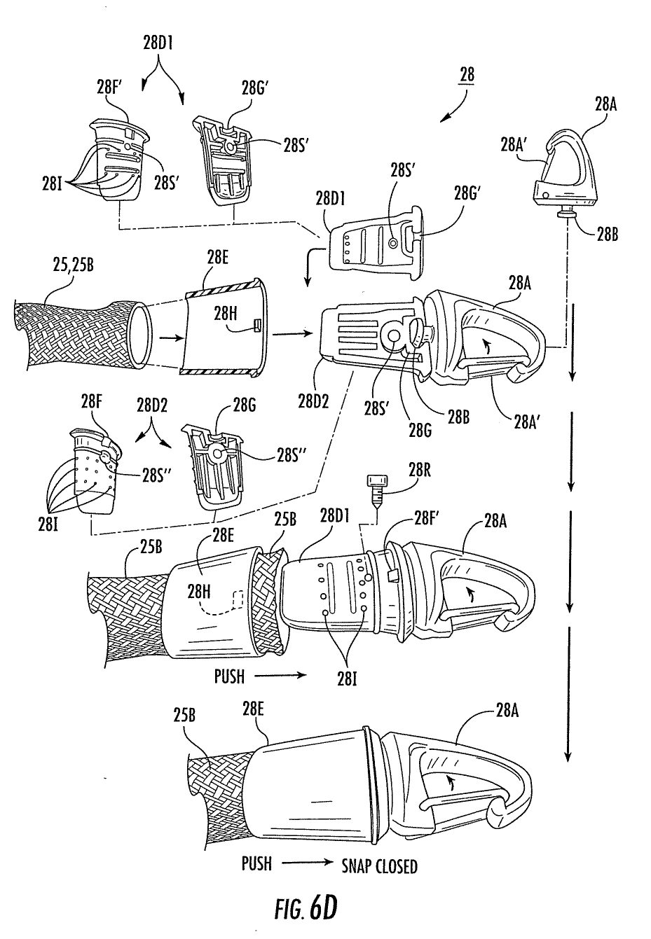

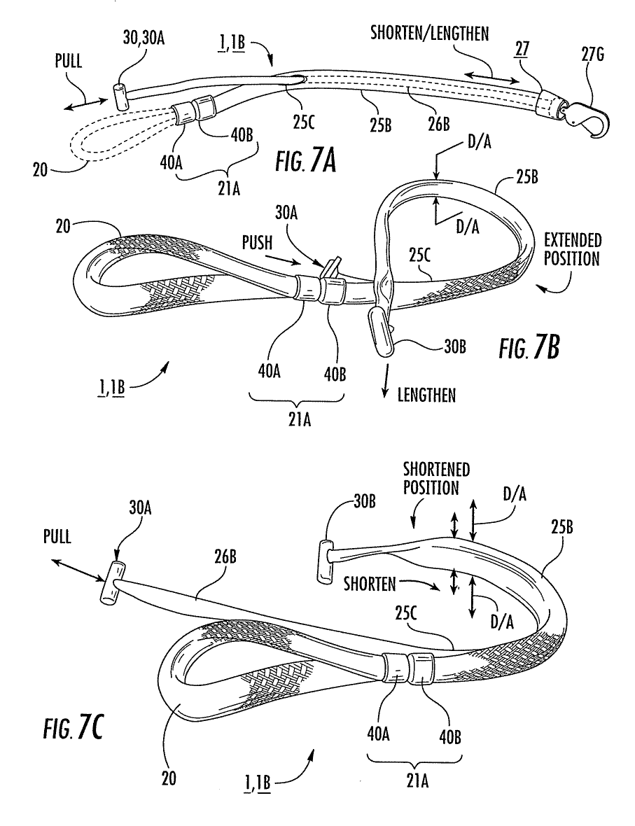

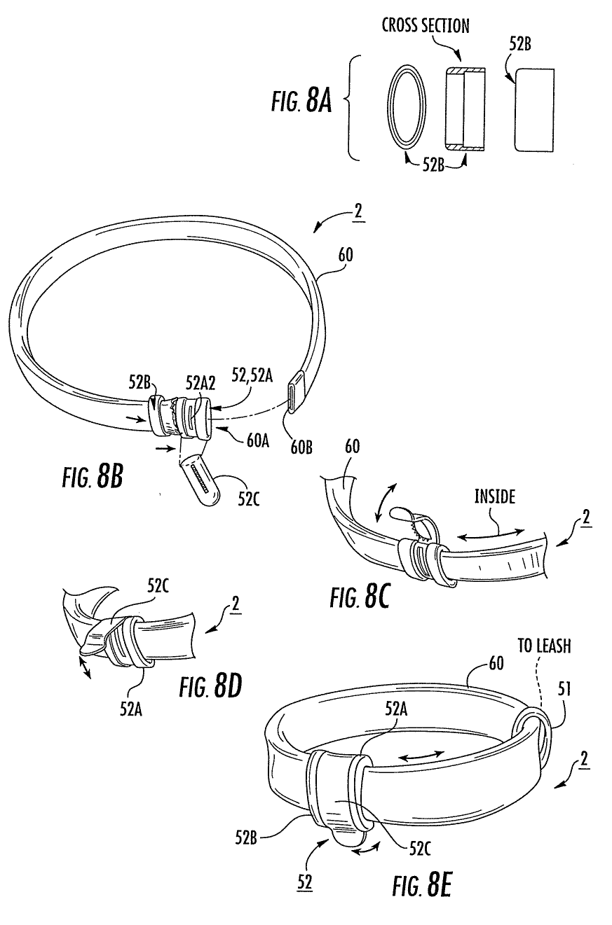

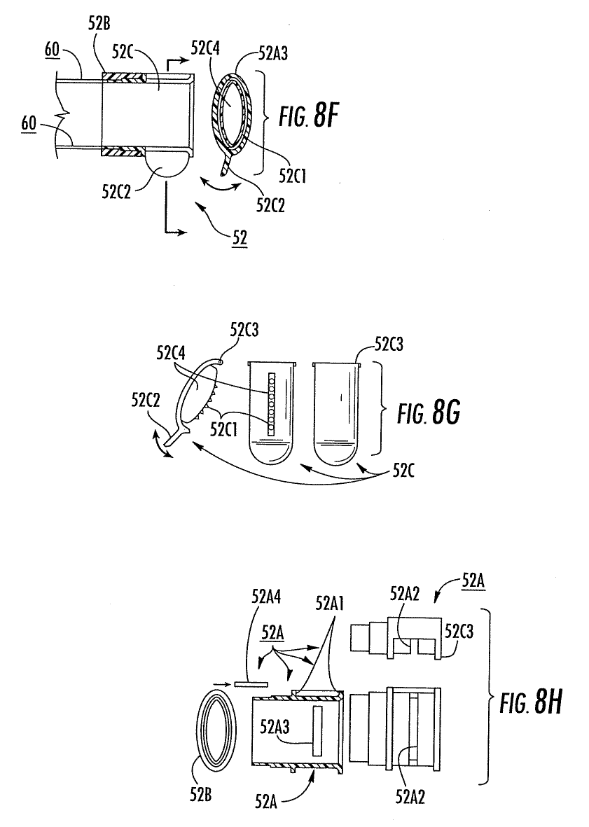

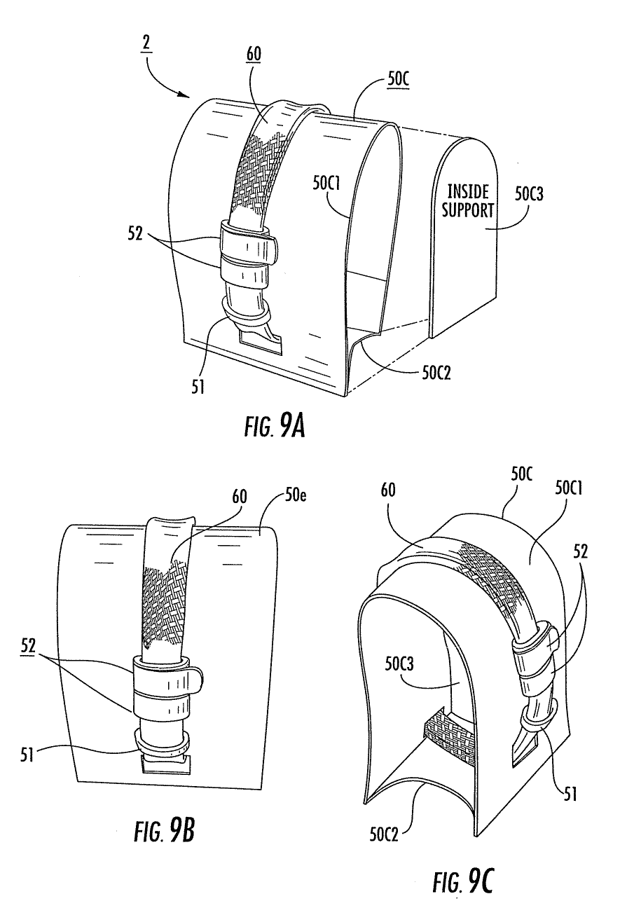

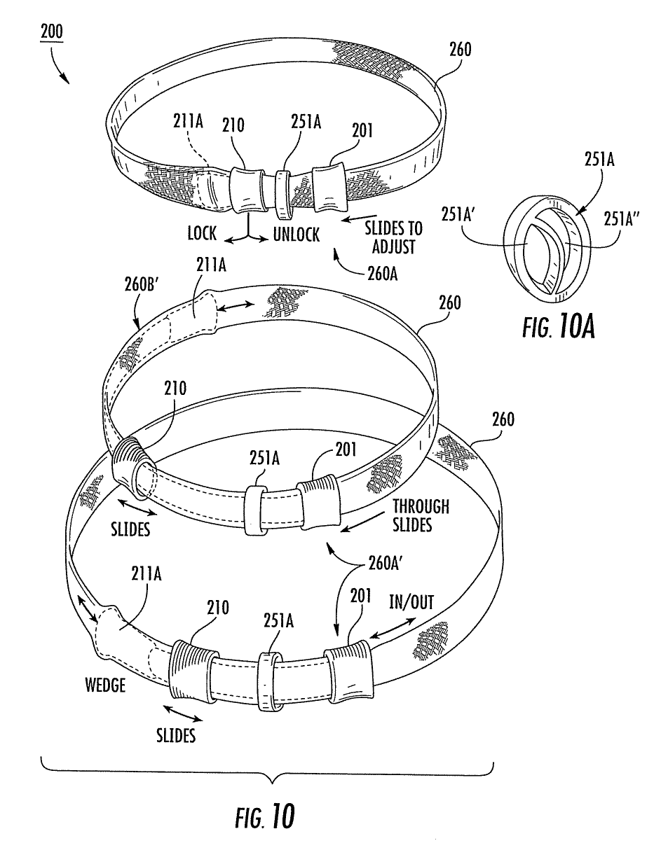

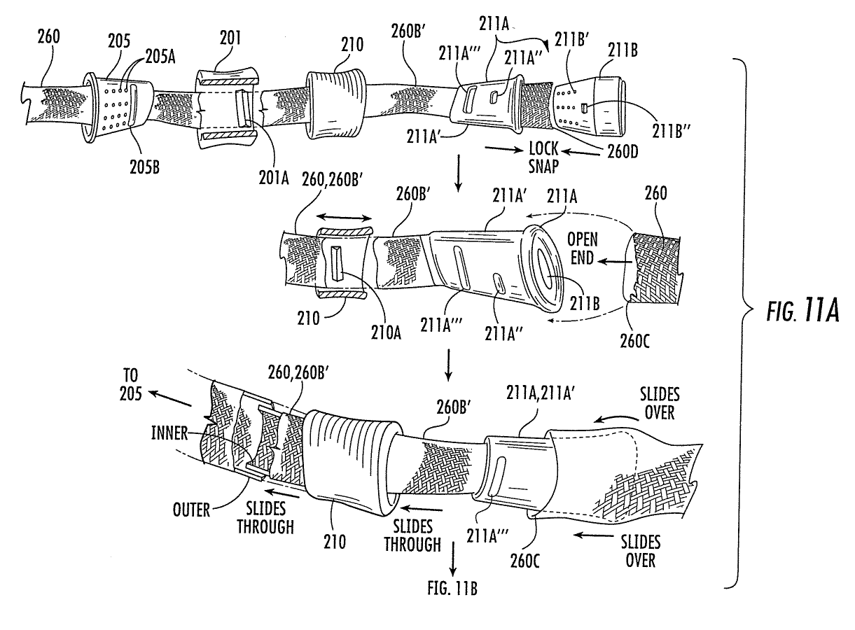

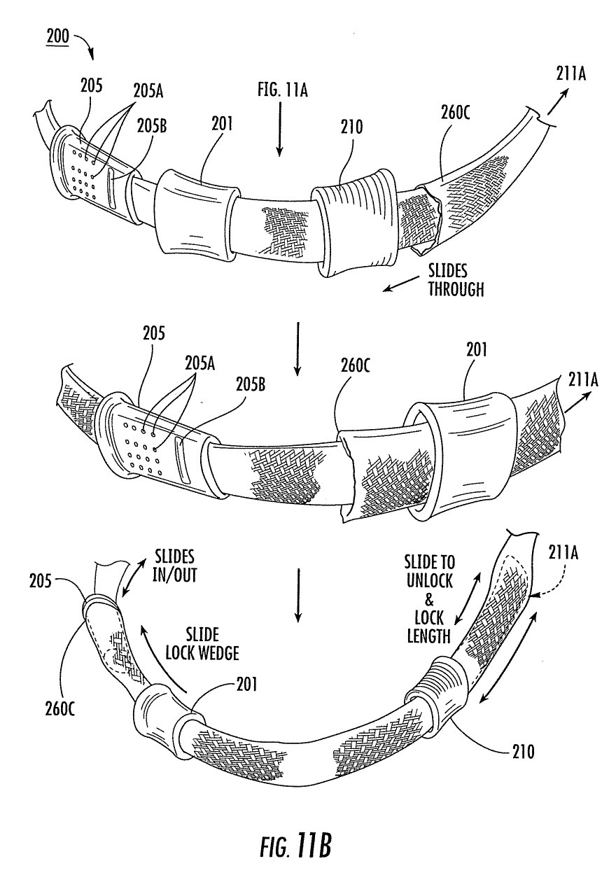

FIG. 1 is an exemplary perspective view of one alternative leash system of the proposed animal restraint system.

FIGS. 2A, 2B, and 2C depict alternative packaging arrangements for a leash system as in FIG. 1 in a compact and convenient display arrangement.

FIGS. 3A, 3B, 3C depict further alternative packaging arrangement for a leash system as in FIG. 1 in a compact and convenient arrangement where the packaging arrangement is readily collapsible prior to assembly with the leash system.

FIG. 4A is a partially cut away front sectional view of a handle portion of a leash system illustrating the dual braided sheath construction therein.

FIG. 4B is an illustrative side partially-cut-away view of FIG. 4A.

FIG. 4C is an illustrative cut away front view similar to FIG. 4A, wherein the outer sheath is noted with the dash-dot lining and the inner sheath is noted along an inner profile as a result of tension being placed thereon.

FIG. 4D is a cross-sectional view along line 4D-4D in FIG. 4C, illustrating the multiple layer arrangement of the dual braided sheath construction with the handle fixing sleeve wherein the braided members are securely retained to resist pulling energy.

FIG. 5 is a partially cut away front cut away illustration of a handle system as in FIG. 4A shown with the optional inclusion of internal compressible plush material between the inner member 26A and the outer member 25A to provide a comfort grip.

FIG. 5A is an alternative schematic illustration of an alternative handle system having a different series of handle fixing member portions and an alternative arrangement providing enhanced retention strength and resistance to damage.

FIG. 6A is an illustrative exploded view of a hook system and hook securing system therewith illustrating the arrangement of individual components. FIG. 6B is a partially assembled view of a hook system prior to insertion with an outer braided sheath portion. FIG. 6C is a partially assembled view following an initial assembly of FIG. 6B prior to final insertion with the outer braided sheath portion. FIG. 6D is an alternative illustrated exploded view of a hook system and kook securing system illustrating the arrangement of alternative individual components according to an alternative arrangement.

FIG. 7A is an illustrative sectional view of a further alternative leash system having an inner braided leash member between the handle and hook system, and for adjusting (shortening or lengthening) a distance from a handle system to a hook system. FIG. 7B is an illustrative alternative leash system as in FIG. 7A with a pull tab and a base tab. FIG. 7C is an illustrative alternative leash system as in FIG. 7B, wherein an inner braided leash member is shortened, thereby shortening the distance from a handle system to a hook system.

FIG. 8A is a tri-part view (end view, cross-section view, side view) of an outer ring member of an alternative collar fixing system. FIG. 8B is a partially assembled view of a collar fixing system with a free end prior to insertion into an inner member. FIG. 8C is a partial view of FIG. 8B with the lock guillotine member in an upright position with free end partially inserted. FIG. 8D is a further partial view of FIG. 8C with the lock guillotine member in a nearly closed position with the teeth entering the slot opening and the free end more completely inserted adjusting for a desired-diameter/length of the collar. FIG. 8E is a fully assembled collar system with a fully closed collar fixing system and an added looped ring for leash attachment. FIG. 8F is an exploded view of an assembled collar fixing system in partial cross-section and end view. FIG. 8G is an assembled illustration of a lock guillotine member shown in a top view (with listing member show) and bottom view (having teeth shown). FIG. 8H is partial illustrative exploded view of an inner member for receiving collar braided portion for the collar system with end view, cross-section, full view, and top corner view noting pivot-pin-insertion arrangement.

FIGS. 9A, 9B, and 9C depict depict alternative packaging arrangements for a collar system in a compact and convenient arrangement for ready display where the collar is tightened about the display for ease of retention and consumer appreciation.

FIG. 10 is an exploded illustrative view of an alternative collar fixing system having internal adjustability and a continuous loop arrangement. FIG. 10A is a illustrative perspective view of an alternative looped ring member. FIGS. 11A, 11B (expanded) illustrates an assembly series of the alternative collar fixing system as noted in FIGS. 10, 10A.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

Referring now to FIGS. 1 through 9C, and initially FIG. 1, a restraint system 10 includes a leash system 1, here shown as a non-extendable/non-retractable leash system type 1A. It will be understood that animal restraint system 10 as discussed herein further includes an optional member, such as a collar system 2, discussed later. As a result, those of skill in the art will understand that ‘restraint’ is used here descriptively and is not specific to a particular use (animal, luggage, transport, etc.) leash, or collar, or combination of leash and collar other than as identified herein below. In a broad sense, the inventions herein may be readily adapted to a variety of uses.

Leash system 1A, as shown, includes a handle system 20 formed of an outer braided sheath 25 material with a outer handle portion 25A and separate leash portion 25B. In handle system 20, an inner braided handle member 26A (shown in dashed lines in FIG. 1) is within outer handle portion 25A as will be discussed herein below (see for example FIG. 4C and FIG. 4A). Leash portion 25B extends along a length to an engagement system 27 shown as a leash engagement system here as a hook member assembly 27A, as shown in FIG. 1.

As also show in in FIG. 1, leash system provides a handle fixing sleeve 21 between joining leash portion 25B and handle portion 25A, and which also serves to secure the position of inner braded handle member 26A at a fixed length that is less than a fixed length of outer handle 25A of outer braided sheath 25 (see in FIG. 1, FIGS. 4A-D, FIG. 5, for further details). The securing between handle fixing sleeve 21 and inner braided handle member 26A and outer braided sheath 25, and handle portion 25A, and leash portion 25B may be accomplished in any convenient manner, but specifically may included mechanical engagement (of any kind), compression, adhesives, thermal bonding and any other form of fixing of a plurality of pieces in relative position to each other. For example (noted herein, and also in FIGS. 4A-4-C, FIG. 5, FIGS. 6A-6C, and others) snap-fit mechanical structures, with or without engagement teeth, may be additionally aided through the use physical entrapment, and use of adhesives, and thermal bonding without departing from the scope and spirit of the present invention. It should be understood that the above means for securing of any component herein (collar, or leash or otherwise) may be similarly supported as being optionally mechanical engagement, physical entrapment, compression, adhesives, thermal bonding, or any other form of fixing between parts in an assembly.

Leash engagement system 27 may also include other forms not limited to the images noted, including mechanical clasps, toggles, buckles, belts, magnetic clamps, and other mechanisms for engaging with an animal securing restraint system (harness, collar, floating device, etc. (all not shown)).

Recognizing that point of purchase (POP) presentation is important to commercial value, compact packaging, attractive design and the need to restrainably contain such a lengthy leash system 1 is discussed herein. As noted in more detail in FIGS. 2A, 2B, and 2C, Applicant has created a bounded container 50A is provided in a cylindraceous form with an opening proximate a top surface for restraining a compacted leash portion. As shown in FIGS. 2A-2C, rounded leash container 50A provides a pleasing appearance, and additionally presents the unique construction, and unique ornamental arrangement of handle system 20. The interior volume could be used for storing product information or other details.

Additionally referring now to FIGS. 3A, 3B, and 3C, an alternative point of purchase support is shown as a flat-pack construction 50B formed of board material having an arcuate front-presentation face 50B1, a rear arcuate support face 50B2, and a spanning support portion 50B3 joining the two in a flexible support for a leash system 1. There is a rear pocket (see FIG. 3B) formed in rear arcuate support face 50B2 for receiving a portion of the rolled up leash portion 25B, and a bottom pocket (shown in FIGS. 3B, 3C, and 3A) for passing through leash system 1 proximate handle fixing sleeve 21. In this manner, leash system 1 is retained compactly, and presents a pleasing upright illustration of the handle system 20. As noted the spanning support portion 50B3 may be connected or otherwise to the other members and therefore may assist in a compact packaging design.

Referring additionally now to handle system 20, as noted in FIGS. 4A, 4B, 4C, 4D, and FIG. 5, and elsewhere. Handle system 20 may take many forms according to the present disclosure as will be understood by those of skill in the art without limitation to the illustrations.

As noted in FIG. 4A, handle system 20 includes an outer braided handle portion 25A as p art of outer braided sheath 25, and an interior or internal braided handle portion 26A, shown in the cut-away views and as can be seen in the partial-views. It will be understood that relative to handle fixing sleeve 21, both outer braided handle portion 25A and inner braided handle portion 26B are of a fixed secured-length (though flexible and extendable to their respective maximum dimensions due to their construction). However, relative to each other, braided outer handle portion 25A is not attached to inner braided handle portion 26B so that each braided-handle-portion can easily and slidable move relative to each other when a user's grasp rotates relative to any leash-tension transmitted via handle fixing sleeve 21 from braided leash portion 25B (see FIG. 1). Additionally, it will be understood, and as shown that an inner geometry maximum extension distance X of braided outer handle portion 25A (for a non-limiting example, about 1 inch in interior dimension) is greater than an outer geometry maximum extension Y of braided inner handle portion 26B (for a non-limiting example, about 0.5 inches in exterior dimension). Therefore, there is created a space (namely X-Y=space (see FIGS. 4B, 5) between inner and outer handle portions 25A, 26A, which may be left empty or optionally filled with a compressible medium 70 (FIG. 5) such as non-woven fiber, plush filling, or other cushioning material. It will additionally be understood that there may be multiple braided inner handle portions 26B (only one is shown). As a result, and as shown in FIG. 4C, when there is a pulling tension applied to handle system 20 the inner handle member 26A (of lesser dimension) takes or bears/holds the tension of any pulling motion while the outer handle member 25A remains relatively relaxed and flexible providing user comfort.

As will be additionally understood that relative to handle fixing sleeve 21, upon assembly, there is a difference in the fixed length between braided outer handle portion 25A and braided inner handle portion 26A, as can be best appreciated in FIG. 4C. Therefore, as a result, this type of double-or-multiple-layer arrangement is provided, wherein any tension stress on handle system 20 (from a pulling event) is first, and nearly exclusively, applied to the braided inner handle portion 26A (or portions 26A if more are provided). As a result, the outer braided outer handle portion 25A remains without tension (or very limited tension) and is therefore fully expanded to provide a plush and squeezably-resilient comfort-fit to a user's hand, even when leash system 1 of animal restraint system 10 is under tension.

The assembly of handle fixing sleeve 21 and outer braided sheath 25, 25A, and inner braided handle portion 26A are discussed in more detail herein below, but is introduced in FIGS. 4D and 5, wherein handle fixing sleeve 21, in the present embodiment has an outer ring portion 21B and a shaped-to-fit inner anvil 21A. Between outer ring portion 21B and inner anvil 21A are fixed the ends of inner braided handle portion 26A and outer braided handle portion 25A. Since, in various alternative constructions outer braided handle portion 25A may continue through fixing sleeve 21 to become outer braided leash portion 25B (e.g., the same braided sheath portion continues), the portions of inner and outer braided handle portions 25A and 26A are fixed to each other and to handle fixing sleeve 21 between ring portion 21 and inner anvil 21A. This fixing may be accomplished in any convenient manner, and may include one or multiple forms of physical entrapment, thermal welding, and adhesive bonding, or other types of fixing. As a result, the fixed length of inner braided handle member 26A is fixed relative to the length of outer braided handle member 25A to provide the above-noted advantages.

Referring now additionally to FIG. 5A, an alternative handle fixing sleeve 21′ is provided for an alternative handle system 20′. As noted, handle system 20′ includes an upper handle portion 25A′ and a lower leash portion 25B′, wherein an internal inner braided handle member 26A′ is secured (internally at a set length) between two heat-sealed holes 20A′, 20A″ formed through both members. As a result, it will be understood that holes 20A′ and 20A″ pass through the combined braided portions of inner braded handle member 26A′ and outer braided handle portion 25A′, which continues downwardly continuously to form an extended leash portion 25B′. It this way, it will be understood that the same outer braded sheath member 25′ may form both the leash portion 25B′ and handle portion 25A′ and this provides increased strength and construction benefits.

As will be noted, an alternative handle fixing sleeve 21′ is provided with an outer sleeve or outer ring 21B′, as shown. Outer ring 21B′ is continuous and ovoidal and has a frustoconical shape. At a narrower end thereof, on an interior surface thereof, are formed teeth 94, 94 that project inwardly toward each other to provide a spring-snap engagement with respective slots 93, 93 of each respective inner anvil portion 21A′, 21A″ (FIG. 5A shows both an outer-surface-side and an inner-surface-side of each respective inner anvil portion via the join-dash-lines). As will be understood, respective inner anvil portions 21A′ and 21A″ have a tapered outer surface formed as one-half of a frustoconical member with a contour that slides within the internal surface of outer ring 21B′ so as to engage therewithin (as shown). The inner surface of a first inner anvil 21A′ is provided with a plurality of gripping teeth 92 and a hole opening 91. The inner surface of a second inner anvil 21A″ is provided with a plurality of gripping teeth 92 and a projecting post 90. Post 90 is shaped to pass through both holes 20A′ and 20A″ (at ends of handle portions 25A′, 26A′) and thus through hole opening 91. Additionally, respective inner anvil portions 21A′ and 21A″ have an intern contour recess that is shaped to receive the crossed-over end portions of inner and outer handle portions 25A′, 26A′. As a result (center image), as the handle portions are pressed together, holes 20A′, 20A″ are aligned, and post 90 is pressed therethrough to engage opening 91. Simultaneously, teeth 92 engage the material of the leash system 1 in a positive manner, and further simultaneously, upon siding into outer ring member 21B′ the sides compress and wedge therewithin. Finally, upon a final insertion motion, teeth/tooth 94, 94 snap into respective slots 93, 93 in each inner anvil portion 21A′, 21A″ and form an elastic fixed assembly for alternative handle system 20′ for a leash 1.

Referring now to FIGS. 6A, 6B, and 6C and hook system 27 which is secured to the end of leash system 1 (FIG. 1) or may be adaptively also linked to the end of a multiple-layer leash arrangement as will be discussed later in FIGS. 7A-7C (wherein hook system 27 is illustrated as a base tab 30B (which may optionally be replaced with a similar hook system 27 or with any other type of engagement fixture). As noted in arrangement FIGS. 6B and 6C, braided outer leash portion 25B has an end (shown), and an outer ring sleeve 27E is positioned thereover. A hook member 27A, includes a receiver member 27B and a pin 27B1 engages the two together, and secures them within receiver member 27B, which is then captured within separate halves of an inner sleeve halves 27D1, 27D2 (which are separable for convenient engagement). The assembly of 27D1, 27D2, and 27B with hook 27A, is then pressed into the open outer end of braided leash portion 25B, and outer sleeve or outer receiver 27E is pressed there on to fix the members together. Additionally, the system may be further bonded by physical entrapment (e.g., engaging step members seen in FIG. 6A in cross-section view but not numbered), by thermal bonding or by adhesive application or by any combination thereof to prevent unintended removal. It will be further understood that the separate members may be formed integrally to convenience and strength, e.g., hook 27A, receiver 27B, sleeves 27D1, 27D2 may be formed as one member for extra strength). Additionally, hook 27, may be formed as a snap hook 27G (FIG. 7A) for convenient securing to a collar looped ring 51 (FIG. 8E) during a use.

Referring additionally now to FIG. 6D a schematic illustrative view of an alternative hook system 28 is provided securing a pivoting hook member 28A with a spring-closing bail 28A′ and an extending receiver 28B shaped to be pivotably secured within respective formed cavities 28G, 28G′ of respective inner sleeves 28D1, 28D2, as will be discussed. A continuous outer ring sleeve 28E is provided with a flattened-frustoconical shape and a pass through opening formed to slidably receive an end a leash portion 25B of the main outer sheath 25 (as will be understood). An inner surface of outer ring sleeve 28E has two opposed locking tabs 28H on each side (only one is shown) which will snap into corresponding outer indents 28F, 28F′ on respective inner sleeves 28D1, 28D2 formed proximate a top outer portion thereof. Inner sleeves 28D1, 28D2 each have respective cavities 28G′, 28G to secure hook system 28A, and are shaped as one-half of a flattened wedge profile to slide within outer ring sleeve 28E as shown. The outer surfaces of each respective inner sleeve 28D1, 28D2 include a plurality of pin teeth 281 that project outwardly therefrom to grip the end of leash portion 25B fixably and trap the end of leash portion 25B within outer ring sleeve 28E to prevent removal. Simultaneously, and prior to insertion within outer ring sleeve 28E, inner sleeves 28D1, 28D1 receive hook system 28A and are placed with their flattened faces together. An alternative threaded member 28R is secured through respective screw holes 28S′, 28S″ so as to fixably join respective inner sleeves 28D1, 28D2 together. Thereafter, outer braided sheath member 25B is slid over the outer surfaces of inner sleeves 28D1, 28D2 and receives pins 281 through the weave, and then the assembly is pressed into outer ring sleeve 28E until tabs 28H, 28H snap into respective cavities 28G, 28G.

Referring additionally now to FIGS. 7A, 7B, and 7C, an alternative leash system 1 for an animal restraint system 10, is provided with a handle portion 20, and previously discussed. Additionally, in the shown version is now a dual-layer assembly of a inner braided leash member 26B that extends within outer braided leash portion 25B. The braided outer leash portion 25B has a bounded slide opening 25C in the outer side wall to allow a portion of inner braided leash member 26B to escape therefrom for manual use as will be discussed. At a pull-end of inner braided leash member 26B is a pull extension pull tab 30A to allow an easy gripping. At the distal end portion of the leash system 1 is shown here a hook system 27 modified to contain a snap hook 27G (FIG. 7A) or with a base tab 30B (FIGS. 7B, 7C) for engagement with a collar system 2. Hook system functions as noted earlier, but is formed in a modified manner with adhesive to functionally join base tab 30B of hook system 27 jointly to the distal end of outer braided sheath leash portion 25B and the distal end of inner braided leash member 26B so that they are co-secured to the hook system 27 in any configuration that can be considered herein. The proximate end of inner braided leash member 26B extends through the outer sleeve opening 25C, as shown. This configuration allows, due to the slidably adjustable and expandable or contractable nature of braided material, a user to rapidly shorten or lengthen the operating distance of outer braided sheath portion 25B and thus the distance of collar system 2 (fixed to hook system 27) from handle system 20. This operable difference also creates an increase in the outer dimension or outer diameter (see FIG. 7C vs. FIG. 7B) of outer braided leash portion 25B as the length shortens. Simultaneously, because the pull tab 30A has a dimension that is larger than an opening dimension of slide opening 25C, upon the application of tension, the length of inner braided leach member 26B will fully enter the internal geometry of outer braided leash portion 25B until pull tab 30A is restrained by slide opening 25C. Additionally, it will be understood as preferable that an outer dimension of inner braided leash member 26B (for example 0.5 inches) is less than the inner dimension of outer braided leash member 25B to allow smooth sliding without interference. In operation, as pull tab 30A is pulled outwardly, the outer dimension of outer braided leash portion 25B increases and the overall length shortens.

In view of the above construction, it will be recognized that handle fixing sleeve 21 (noted above) is reconfigured into a handle sleeve system 21A with two separable fixing sleeves 40A and 40B. As noted above, the handle-side fixing sleeve 40A functions similarly to fix relative to each other inner braided handle member 26A and outer braided handle member 25A. Similarly, the leash-side fixing sleeve 40B secures the top portion of outer braided leash member 25B. It should be understood that fixing sleeves 40A, 40B may be formed in a continuous unitary member (as in FIG. 1 with fixing sleeve 21) and need not be separately formed (as shown in FIG. 7B).

Referring now to FIGS. 8A through 8H, collar system 2 is described as providing an adjustable braided collar sleeve form 60, adjustable relative to a collar fixing system 52 and supporting a looped ring 51 for slidably linking with hook system 27 or other restraint system.

Braided collar sleeve form 60 is also formed of braided material as discussed herein and has a distal end 60B with a sealed end, and an open adjustable end 60A. In practice distal end is slidably adjustable into adjustable end 60A to adjust braided collar sleeve form 60 to different lengths to meet various need (small neck pet vs. large neck pet). The distal end 60B is sealed closed vial thermal welding, adhesive bonding, or other means to form a narrow end for easy sliding entry.

Adjustable end 60A is held in an open form by an assembly of an inner member 52A having a sleeve end for engaging sleeve form 60 and an open end as shown. An outer ring 52B is formed with a similar inner profile as the outer profile of inner member 52A so that when assembled with the end of sleeve form 60 they may be mechanically secured, thermally bonded, adhesively linked or otherwise permanently fixed together. This leaves an open end, as shown in FIG. 8H which is proximate a locking groove 52A2 formed in an outer portion thereof and a co-aligned inner slot 52A3 formed in the inner side wall of the open end (see. FIG. 8H and FIG. 8F) (directly below the locking groove 52A2. A pivoting locking tongue 52C is pivotably secured on an outer portion of inner member 52A via a pin 52A4 slidably secured in opposing pivot holes 52A1 (see FIG. 8H) to secure a pivot axis 52C3 of locking tongue 52C. Extending from locking tongue 52C is a blade part 52C4 having extending therefrom a plurality of gripping members or teeth 52C1 and a lift handle portion 52C2 as shown for easy operation. During a use, distal end 60B is length-adjusted through collar fixing system 52, and locking tongue 52C is pivotably pressed through outer slot 52A2 to engage the full cross-sectional surface of distal end 60B and pass therethrough (due to the braided sheath construction) with teeth 52C1 extending into inner groove 52A3 to provide a compression and a complete physical entrapment of distal end 60B that prevents unintended removal during tension force application without damage to the braided sheath construction of distal end 60B. Release of lift handle 52C2, removes the physical entrapment and allows slidable adjustability and re-securement.

Referring additionally now to FIGS. 9A, 9B, and 9C an additional collar display 50C for point of purchase (POP) display is provided. As shown, display 50C is formed of a folded lateral member in a U-shape 50C1, with an inner spring bottom member 50C2. As a result, there is spring-flexibility to tension collar system 2 shown in display via a looped from and front and rear openings in U-shaped member 50C1. To aid in support a removable inner support 50C3, also having a co-supporting outer profile may be inserted internally between U-shape lateral member 50C1 and inner spring bottom member 50C2. As a result collar display 50C provides enhanced support for collar system 2 in a convenient arrangement, and which can be constructed from initially flat material (fiber board, paper, plastic etc.) formed into spring-tension elements as shown (top U-member forms a spring as does the bottom member adding an urging tension to collar system 2).

Referring now to FIGS. 10, 10A, and 11A, 11B, an alternative infinitely adjustable collar system 200 is provided relative to a braided collar portion 260 having two open ends (initially before assembly). Collar system 200 further includes as component members a slidable anchor 201 slidably joinable to an open anchor wedge member 205 which secures fixably a first loose end 260C of collar portion 260 forming an open end 260A′ upon assembly altogether. An inner wedge assembly 211A is joined to an opposite loose end 260D as will be discussed. Inner wedge assembly 211A includes an inner wedge outer portion 211A′ and an inner wedge inner portion 211B (which are assembled together with second loose end 260D to form closed end 260B′).

As is show, inner wedge inner 211B is formed with a tapered profile having a plurality of gripping pins 211B′ on an outer tapered surface thereof. Also on the opposed outer surface thereof are respective teeth 211B″ (there are two opposed teeth 211B″ on either side of inner wedge inner member 211B). During assembly, second loose end 260D is guided up and over the outer tapered surface of inner wedge inner member 211B and is secured via gripping pins 211B′. Inner wedge outer 211A′ is hollow and contains a similarly tapered inner surface to match with the outer tapered surface of inner wedge inner 211B. The tapered inner surface of inner wedge outer 211A′ has additional gripping pins (not shown), and has two opposed-side openings 211A″. Each opposed-side opening 211A″ receives upon assembly a snap fit with projecting teeth 211B″ from and thereby fixably secures inner wedge outer 211A′ to inner wedge inner 211B′ and simultaneously second loose end 260D therebetween forming (upon assembly) in total closed end 260B of collar assembly 200. Additionally on the outer tapered surfaces of outer wedge outer 211A′ are formed two opposed outer grooves 211A′″. During later slide adjustment assembly a sliding lock 210 is provided with two opposed projecting inner bars 210A, 210A which snap-fit within respective two opposed outer grooves 211A″′, 211A″′ thereby trapping therebetween a selected portion of collar portion 260 in an adjustment manner (e.g., slide lock 210 may be slid onto and off of inner wedge assembly 211A at desired positions along the length of collar 260 along infinite sliding adjustment.

The first loose end 260C passes over inner wedge assembly 211A, and through sliding lock 210 and through anchor member 201 to slide over an outer surface of hollow anchor wedge 205. An outer surface of anchor wedge 205 includes a plurality of pins 205A which extend through and secure first loose end 260C thereonto. The outer surface of wedge anchor 205 also includes two opposed grooves 205B, 205B (only one side is shown). Next, sliding anchor 201 slides up and over anchor wedge 205 and first loose end 260C trapping first loose end 260C thereon. On two opposed inner surfaces of anchor 201 (see partial cross-sectional view in FIG. 11A) are respective projecting anchor bars 201A, 201A shaped to snap fit within respective grooves 205B, 205B on respective sides of anchor wedge 205. Upon assembly a snap-link between slide anchor 201 and anchor wedge 205 form open end 260A, wherein the opening in anchor wedge allows the braided member 260 to slide back-and-forth therethrough (and adjust a length thereby). When a desired length is determined, sliding lock 210 is slid up and over inner wedge assembly 211A (via the interfit between anchor bars 210A, 210A and pressing into the collar sleeve side wall 260 covering over the openings 211A′″, 211A′″ on the outer surfaces of inner wedge outer 211A′ and snapping the into place) and fixing the collar assembly 200 to a desired length. To adjust the length (diameter) of collar assembly 200, a user merely slides sliding lock 210 back off inner wedge assembly 211A, slides a desired length of closed end 260B relative to open end 260A, and then slides sliding lock 210 back onto inner wedge assembly 211A trapping collar sleeve 260 at a desired location.

An adaptive snap ring 251A is provided, as shown and receives through the opening thereof 251A′ the collar 260 so that a hook (e.g., hook 28A) may be snapped into opening 251A″ to secure collar system to the leash system. As a result, it will be clear that any collar system herein may be used separately from any leash system herein with full adaptation to a user's needs.

It will be understood, that while presented as animal restrain systems in combination, any collar system or any leash system or any hook system may be used fully independently and separately.

As used herein the phrase ‘braided’ will be understood to have a structure that is similar to the braided sleeve products discussed herein and is formed from a plurality of individual strands, without limitation to the type of braiding or strand arrangement of the structure.

Additionally, while the present discussion notes the use of ‘animal’ restraint, nothing herein should so limit the application thereof, and it will be understood that the present invention may be applied to any form of restraint (e.g., cargo, luggage transport, travel industry, etc.) without departing from the scope and spirit of the present invention.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A restraint system, comprising:
a leash system having an outer braided sheath with a handle system at a first end and a hook system at a second end;
said handle system including an outer braided handle portion and extending on an inside therethrough is an inner braided handle portion therein each respectively fixed to a handle fixing assembly;
said outer braided handle portion having a first length relative to said handle fixing assembly and said inner braided handle portion having a second length relative to said inner fixing member; and
said first length being greater than said second length, whereby a force applied to said handle fixing assembly first tensions said inner braided handle portion during a use and does not tension said outer braded handle portion.

2. The restraint system, according to claim 1, further comprising:
an outer braided leash portion along said outer braided sheath and secured between said handle fixing member at a first end and said hook system at said second end;
an inner braided leash portion having extending within said outer braided leash portion and fixed to said hook system at a first inner braded leash end;
a bounded opening along a side wall of said outer braided leash portion;
a second inner braded leash end opposite said first inner braded leash end; and
a portion of said second inner braded leash end of said inner braided leash portion extending through said bounded opening during said use, thereby enabling a manual adjustment of a use-length of said outer braided leash portion.

3. The restraint system, according to claim 1, wherein:
said handle fixing assembly further comprising:
an outer handle fixing sleeve having an inner tapered profile surface and at least one engagement contour therein;
a first and a second inner anvil member each respectively having an outer contour that is a portion of said inner tapered profile surface of said outer handle fixing sleeve;
each outer contour of said first and said second inner anvil members having a respective receiving contour shaped to engage said one engagement contour of said outer handle fixing sleeve and secure said first and said second inner anvil members within said outer handle fixing sleeve;
said first and said second inner anvil members each respectively having an inner receiving contour profile and at least one engagement member; and
a respective first end portion of said handle system and a second end portion of said handle system received within said first and said second inner anvil members and aligned with said inner receiving contour profiles and engaging said at least one engagement member whereby respective lengths of said inner braided handle portion and said outer braided handle portion are fixed relative to said handle fixing assembly.

4. The restraint system, according to claim 3, further comprising:
a first bounded opening in said respective first end portion of said handle system and a second bounded opening in said send end portion of said handle system;
said at least one engagement member on at least one of said inner receiving contour profiles of said first and said second inner anvil members; and
said at least one engagement member extending through said first and said second bounded openings of said handle system and engaging said other of said inner receiving contour profiles of said first and said second inner anvil members.

5. The restraint system, according to claim 1, wherein:
said handle fixing assembly further comprising:
an outer handle fixing sleeve having an inner tapered profile surface and at least one engagement contour therein;
an inner anvil member having an outer tapered profile surface corresponding to said inner tapered profile of said outer fixing sleeve whereby upon insertion of said inner anvil member into said outer handle fixing sleeve said inner tapered profile surface and said outer tapered profile surface are urged into contact; and
a respective first end portion of said handle system and a second end portion of said handle system received between said inner tapered profile surface of said outer handle fixing sleeve and said outer tapered profile surface of said inner anvil member, whereby respective lengths of said inner braided handle portion and said outer braided handle portion are fixed relative to said handle fixing assembly.

6. The restraint system, according to claim 1, wherein:
said second end of said outer braided sheath of said leash system having an open second end fixably engaging said hook system;
said hook system further comprising:
a hook;
an outer hook ring sleeve member having an inner contour;
an inner hook sleeve member having an outer contour and engaging said hook;
an inner surface of said open second end of said outer braided sheath on said outer contour of said inner hook sleeve member;
an outer surface of said open send end of said outer braided sheath pressed by said inner contour of said outer hook ring sleeve member during assembly;
at least one inner hook sleeve engaging profile on said outer contour of said inner hook sleeve member;
at least inner contour engaging profile on said outer hook ring sleeve member; and
said inner hook sleeve engaging profile fixably engaging said inner contour engaging profile thereby securing said second end of said outer braided sheath to said hook system.

7. The restraint system, according to claim 6, wherein:
said inner hook sleeve member is a first inner sleeve and a second inner sleeve;
said outer contour of said hook sleeve member is a first outer contour portion and a second outer contour portion of respective said first inner sleeve and said second inner sleeve;
a plurality of hook sleeve engaging profiles on respective said first outer contour portion and said second outer contour portion.

8. The restraint system, according to claim 7, wherein:
said first inner sleeve and said second inner sleeve each further comprise a respective first threaded opening and a respective second threaded opening; and
said inner hook sleeve member further comprises a threaded member threadaby engaging respective said first and said second threaded openings thereby securing said first inner sleeve to said second inner sleeve.

9. The restraint system, according to claim 6, further comprising:
a pivot member protruding from said hook;
a pivot receiving cavity in said inner hook sleeve member; and
said hook in said hook system being pivotably secured to said second end of said outer braided sheath.

10. A restraint system, comprising:
a collar system having a collar braided sleeve portion with a first open end and a second closed end;
a collar fixing system secured to said first open end of said collar braided sleeve portion;
said second closed end adjustably sliding through said collar fixing system and into an inner portion of said collar braided sleeve portion during an adjustment to a selected length thereby forming a continuous loop; and
a locking system for securely engaging between said collar fixing system and a designed portion said second closed end during said adjustment, whereby said collar system provides an infinite adjustability of a dimension of said continuous loop.

11. A restraint system, comprising:
a collar system including a braided sleeve portion having a first open loose end and a second open loose end;
an inner wedge assembly having a inner wedge inner portion with an inner wedge outer profile and an inner wedge outer portion with an inner wedge inner profile;
said inner wedge outer profile being complementary to said inner wedge inner profile;
said inner wedge outer profile including a plurality of inner wedge engaging members;
said first open loose end on said inner wedge outer profile engaging at least one of said plurality of inner wedge engaging members;
said inner wedge outer profile of said inner wedge outer portion fixably engaging said first open loose end and said inner wedge inner portion and forming a closed end of said collar system;
said closed end of said collar system being within said braided sleeve portion forming a continuous adjustable loop;
said inner wedge outer portion having an inner wedge exterior profile and at least one receiving recess;
an open anchor wedge having an open inner passage and an outer anchor wedge profile including a plurality of anchor wedge fixing engaging protuberances and at least one releasable engaging protuberance;
said second open loose end on said outer anchor wedge profile and fixably engaging said anchor wedge fixing engaging protuberances and a portion of said braided sleeve portion extending through said open inner passage forming said continuous adjustable loop;
an anchor member slidably adjustable along said braided sleeve portion and having an inner profile shaped to releasably engage said releaseable engaging protuberance of said open anchor wedge thereby securing said second open loose end to said open anchor wedge forming an open end for said collar system;
said closed end of said collar system being slidably and adjustably received within said open end for said collar system and a sliding lock member being slidably positioned along said continuous adjustable loop; and
said sliding lock member having an inner surface with at least one lock protuberance being releasably engagable with said at least one receiving recess of said inner wedge outer portion; whereby during an adjustment use said sliding lock member releasably disengages said inner wedge outer portion of said inner wedge assembly and after said adjustment said sliding lock member engages said inner wedge portion at a desired location along said continuous adjustable loop.

12. A restraint system, further comprising:
a leash system having an outer braided sheath with a handle system at a first end and a hook system at a second end;
said handle system including an outer braided handle portion and extending on an inside therethrough is an inner braided handle portion therein each respectively fixed to a handle fixing assembly;
said outer braided handle portion having a first length relative to said handle fixing assembly and said inner braided handle portion having a second length relative to said inner fixing member;
said first length being greater than said second length, whereby a force applied to said handle fixing assembly first tensions said inner braided handle portion during a use and does not tension said outer braded handle portion;
a collar system having a collar braided sleeve portion with a first open end and a second closed end;
a collar fixing system secured to said first open end of said collar braided sleeve portion;
said second closed end adjustably sliding through said collar fixing system during an adjustment to a selected length; and
a locking system for securely engaging between said collar fixing system and said second closed end during said adjustment.

13. The restraint system, according to claim 12, further comprising:
an outer braided leash portion along said outer braided sheath and secured between said handle fixing assembly at a first end and said hook system at said second end;
an inner braided leash portion having extending within said outer braided leash portion and fixed to said hook system at a first inner braded leash end;
a bounded opening along a side wall of said outer braided leash portion;
a second inner braded leash end opposite said first inner braded leash end; and
a portion of said second inner braded leash end of said inner braided leash portion extending through said bounded opening during said use, thereby enabling a manual adjustment of a use-length of said outer braided leash portion.

14. A restraint system, comprising:
a leash system having an outer braided sheath with a handle system at a first end and a hook system at a second end;
said handle system including an outer braided handle portion and extending on an inside therethrough is an inner braided handle portion therein each respectively fixed to a handle fixing assembly;
said outer braided handle portion having a first length relative to said handle fixing assembly and said inner braided handle portion having a second length relative to said inner fixing member;
said first length being greater than said second length, whereby a force applied to said handle fixing assembly first tensions said inner braided handle portion during a use and does not tension said outer braded handle portion;
said handle fixing assembly further comprising:
an outer handle fixing sleeve having an inner tapered profile surface and at least one engagement contour therein;
a first and a second inner anvil member each respectively having an outer contour that is a portion of said inner tapered profile surface of said outer handle fixing sleeve;
each outer contour of said first and said second inner anvil members having a respective receiving contour shaped to engage said one engagement contour of said outer handle fixing sleeve and secure said first and said second inner anvil members within said outer handle fixing sleeve;
said first and said second inner anvil members each respectively having an inner receiving contour profile and at least one engagement member; and
a respective first end portion of said handle system and a second end portion of said handle system received within said first and said second inner anvil members and aligned with said inner receiving contour profiles and engaging said at least one engagement member whereby respective lengths of said inner braided handle portion and said outer braided handle portion are fixed relative to said handle fixing assembly;
a collar system having a collar braided sleeve portion with a first open end and a second closed end;
a collar fixing system secured to said first open end of said collar braided sleeve portion;
said second closed end adjustably sliding through said collar fixing system and into an inner portion of said collar braided sleeve portion during an adjustment to a selected length thereby forming a continuous loop; and
a locking system for securely engaging between said collar fixing system and a designed portion said second closed end during said adjustment, whereby said collar system provides an infinite adjustability of a dimension of said continuous loop.
